(19) United States
(12) Patent Application Publication
(10) Pub. No.: US 2025/0313134 A1
(43) Pub. Date: Oct. 9, 2025

(54) EXIT ASSISTANCE DEVICE OF VEHICLE

(71) Applicant: SUBARU CORPORATION, Tokyo (JP)

(72) Inventors: Koki MATSUMOTO, Tokyo (JP); Keita Nakahashi, Tokyo (JP)

(73) Assignee: SUBARU CORPORATION, Tokyo (JP)

(21) Appl. No.: 19/078,749

(22) Filed: Mar. 13, 2025

(30) Foreign Application Priority Data
Apr. 5, 2024 (JP) 2024-061251

(51) Int. Cl. B60N 2/02; B60N 2/75

(52) U.S. Cl. CPC B60N 2/0279; B60N 2/0256; B60N 2/0268; B60N 2/773

(57) ABSTRACT

An exit assistance device of a vehicle includes a console member, a first actuator, a controller, a driver-side sensor, and a front passenger-side sensor. The controller is configured to, while the vehicle is stationary, determine whether a driver's door is openable and closable based on detection by the driver-side sensor, and determine whether a front passenger's door is openable and closable based on detection by the front passenger-side sensor. The controller is configured to, when it is determined that the driver's door is not openable and closable or when it is determined that the front passenger's door is not openable and closable, move at least an upper part of the console member backward toward a rear side in a front-rear direction of the vehicle by controlling the first actuator.

### CROSS-REFERENCE TO RELATED APPLICATIONS

The present application claims priority from Japanese Patent Application No. 2024-061251 filed on Apr. 5, 2024, the entire contents of which are hereby incorporated by reference.

### BACKGROUND

The disclosure relates to an exit assistance device of a vehicle.

Occupants including a driver who drives a vehicle, such as an automobile, enter and exit the vehicle. Japanese Unexamined Patent Application Publication (JP-A) No. 2020-128151 discloses a function of assisting getting into and out of a seat in a second row by storing information on an entry and exit space outside a vehicle in a memory.

Japanese Unexamined Patent Application Publication (JP-A) No. 2005-009157 discloses opening a door while detecting a distance between the door and an obstacle outside a vehicle by an obstacle detection sensor.

Japanese Unexamined Patent Application Publication (JP-A) No. 2006-256487 discloses that a console body is slidable in a vehicle front-rear direction along a slide rail installed on a vehicle body floor in the vehicle front-rear direction.

### SUMMARY

An exit assistance device of a vehicle according to one form of implementation of the disclosure includes a console member, a first actuator, a controller, a driver-side sensor, and a front passenger-side sensor. The console member is provided between a driver seat and a front passenger seat in a vehicle cabin of the vehicle. The first actuator is configured to move at least an upper part of the console member backward toward a rear side in a front-rear direction of the vehicle. The controller is configured to control the first actuator. The driver-side sensor is configured to detect an obstacle outside the vehicle within an opening-closing range of a driver's door. The driver's door is configured to open and close when an occupant gets into or out of the driver seat. The front passenger-side sensor is configured to detect an obstacle outside the vehicle within an opening-closing range of a front passenger's door. The front passenger's door is configured to open and close when an occupant gets into or out of the front passenger seat. The controller is configured to, while the vehicle is stationary, determine whether the driver's door is openable and closable based on the detection by the driver-side sensor. The controller is configured to, while the vehicle is stationary, determine whether the front passenger's door is openable and closable based on the detection by the front passenger-side sensor. The controller is configured to, when the controller determines that the driver's door is not openable and closable or when the controller determines that the front passenger's door is not openable and closable, move the at least an upper part of the console member backward toward the rear side in the front-rear direction of the vehicle by controlling the first actuator.

An exit assistance device of a vehicle according to one form of implementation of the disclosure includes a console member, a first actuator, a circuitry, a driver-side sensor, and a front passenger-side sensor. The console member is provided between a driver seat and a front passenger seat in a vehicle cabin of the vehicle. The first actuator is configured to move at least an upper part of the console member backward toward a rear side in a front-rear direction of the vehicle. The circuitry is configured to control the first actuator. The driver-side sensor is configured to detect an obstacle outside the vehicle within an opening-closing range of a driver's door. The driver's door is configured to open and close when an occupant gets into or out of the driver seat. The front passenger-side sensor is configured to detect an obstacle outside the vehicle within an opening-closing range of a front passenger's door. The front passenger's door is configured to open and close when an occupant gets into or out of the front passenger seat. The circuitry is configured to, while the vehicle is stationary, determine whether the driver's door is openable and closable based on the detection by the driver-side sensor. The circuitry is configured to, while the vehicle is stationary, determine whether the front passenger's door is openable and closable based on the detection by the front passenger-side sensor. The circuitry is configured to, when the circuitry determines that the driver's door is not openable and closable or when the circuitry determines that the front passenger's door is not openable and closable, move the at least an upper part of the console member backward toward the rear side in the front-rear direction of the vehicle by controlling the first actuator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a vehicle cabin of an automobile according to an embodiment of the disclosure as seen through from above;

FIG. 2 is an explanatory view of how a driver and a front passenger enter and exit in a state where there is a wall on a left outer side of the automobile of FIG. 1;

FIG. 3 is an explanatory view of main components of an exit assistance device of the automobile of FIG. 1;

FIG. 4 is a flowchart of a main process of exit control for the driver and the front passenger by a control device of FIG. 3;

FIG. 5 is a flowchart about the rest of the process of the exit control of FIG. 4;

FIG. 6 is an explanatory view of a position of a driver seat and a position of a console box when the driver is in a driving position;

FIG. 7 is an explanatory view of the position of the driver seat and the position of the console box when the driver and the front passenger exit;

FIG. 8 is a flowchart of a main process of control during entry of the driver and the front passenger by the control device of FIG. 3;

FIG. 9 is an explanatory view of a console box according to a modified example that is divided into upper and lower halves; and

FIG. 10 is an explanatory view of a state where an upper member of the console box of FIG. 9 that is divided into the upper and lower halves has moved farthest backward with respect to a lower member of the console box.

### DETAILED DESCRIPTION

Incidentally, a driver and a front passenger exit a vehicle by opening and closing doors in a state where the vehicle has been parked in a predetermined parking space etc. The driver and the front passenger enter the vehicle by opening and closing the doors of the vehicle parked in a parking space etc.

However, depending on the size of the parking space or the surrounding circumstances, the driver and the front passenger may be unable to open and close their respective doors. For example, when a wall or the like is present within an opening-closing range of the driver's door, the driver may be unable to enter or exit the vehicle by opening and closing the driver's door. In this case, the driver sometimes moves from the driver seat to the front passenger seat and exits the vehicle by opening and closing the front passenger's door. When a wall or the like is present within an opening-closing range of the front passenger's door, the front passenger may be unable to enter or exit the vehicle by opening and closing the front passenger's door. In this case, the front passenger sometimes moves from the front passenger seat to the driver seat and exits the vehicle by opening and closing the driver's door.

On the other hand, in a vehicle cabin of the vehicle, a console member is provided between the driver seat and the front passenger seat. As a result, for example, when the driver moves from the driver seat to the front passenger seat, the movement may be hindered by the console member that protrudes therebetween. Movement of the front passenger from the front passenger seat to the driver seat may also be hindered by the console member that is provided so as to protrude between the driver seat and the front passenger seat. The driver and the front passenger who try to enter or exit the vehicle may move inside the vehicle while folding their legs inside the vehicle so as to avoid the protruding console member. In some cases, the driver etc. move between the seats after holding his or her leg by hand and bringing the leg to the opposite side of the console member provided so as to protrude. When a child is seated in the front passenger seat, the child may walk over the seat or crawl to move to the opposite side of the protruding console member.

Thus, vehicles have room for improvement in terms of reducing the effort taken for a driver or a front passenger to enter or exit from the side of a seat of the vehicle different from a seat in which the drive or the front passenger has been seated.

In the following, an embodiment of the disclosure will be described based on the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

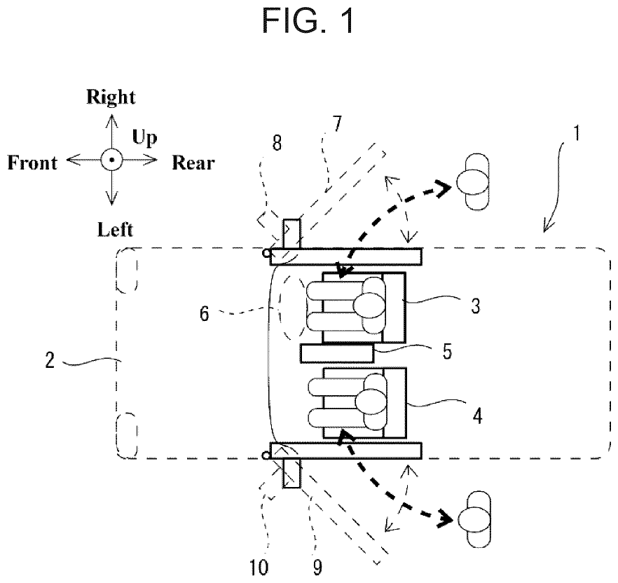

FIG. 1 is a schematic plan view of a vehicle cabin of an automobile 1 according to the embodiment of the disclosure as seen through from above. In FIG. 1, a vehicle body 2 of the automobile 1 is indicated by dashed lines and an inside of the vehicle cabin and peripheral members of the automobile are indicated by solid lines. The automobile 1 is one example of vehicles. Other examples of vehicles include a van, a bus, a truck, and a personal mobility. The automobile 1 of FIG. 1 has the vehicle body 2. In the vehicle cabin of the vehicle body 2, a driver seat 3, a front passenger seat 4, and a console box 5 are provided.

The driver seat 3 is a seat in which the driver who is an operation manager of the automobile 1 sits. A steering wheel 6 a brake pedal (not illustrated), an accelerator pedal (not illustrated), etc. that the driver operates are provided in front of the driver seat 3. The front passenger seat 4 is a seat that is provided next to the driver seat 3 in a right-left direction that is a vehicle width direction of the automobile 1 and is a seat in which an occupant other than the driver sits as a front passenger. The console box 5 is a console member provided between the driver seat 3 and the front passenger seat 4. The console box 5 is sometimes provided so as to have a height upward and be usable as an armrest for the driver or the front passenger. In this case, the console box 5 can be provided such that an upper surface of the console box 5 is located at a higher level than a seating surface of the driver seat 3 and a seating surface of the front passenger seat 4.

In the vehicle body 2 of the automobile 1, a right door 7 as a driver-side door and a left door 9 as a front passenger-side door are provided. The right door 7 is provided on an outer side of the driver seat 3 in the vehicle width direction of the automobile 1 so as to be openable and closable. On the right door 7, a right door mirror 8 is provided. In the embodiment, the right door 7 serves as a driver's door. The left door 9 is provided on an outer side of the front passenger seat 4 in the vehicle width direction of the automobile 1 so as to be openable and closable. On the left door 9, a left door mirror 10 is provided. In the embodiment, the left door 9 serves as a front passenger's door.

In this case, the driver can get into the automobile 1 by opening the right door 7 and sit in the driver seat 3. The front passenger can get into the automobile 1 by opening the left door 9 and sit in the front passenger seat 4. Then, the driver confirms that the right door 7 and the left door 9 are closed, and turns a start button 21 on to put the automobile 1 in a travelable state. The driver makes the automobile 1 travel by operating the steering wheel 6, the brake pedal, the accelerator pedal, etc. When the automobile 1 arrives at a destination, the driver parks the automobile 1 in a parking lot etc. After parking the automobile 1 in a parking lot etc., the driver turns the start button 21 off to put the automobile 1 in an untravelable state, and exits the automobile 1 by opening the right door 7. The front passenger exits the automobile 1 by opening the left door 9.

Thus, the automobile 1 has the right door 7 for the driver and the left door 9 for the front passenger. In the case of FIG. 1, the driver can smoothly enter and exit by opening and closing the right door 7. The front passenger can smoothly enter and exit by opening and closing the left door 9.

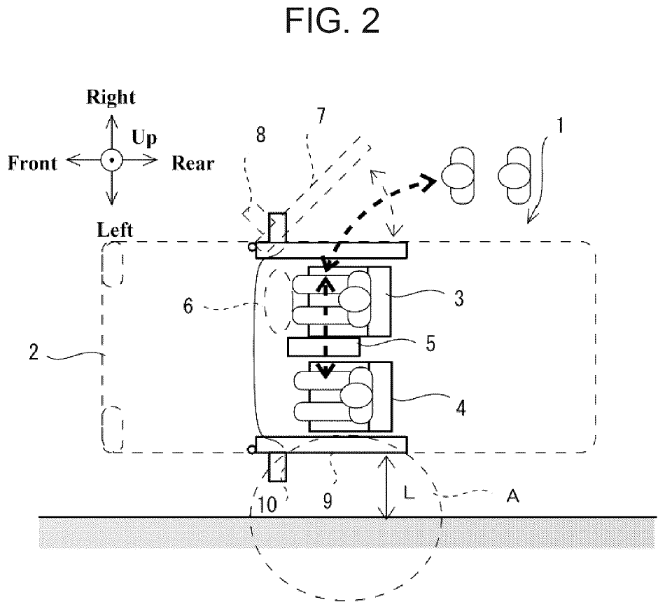

FIG. 2 is an explanatory view of how the driver and the front passenger enter and exit in a state where there is a wall on a left outer side of the automobile 1 of FIG. 1. In the case of FIG. 2, as the wall is present on the left outer side of and close to the automobile 1, it is difficult to open the left door 9.

Therefore, the front passenger may enter and exit the automobile 1 from the right door 7 instead of the left door 9. When entering the automobile 1, the front passenger may open and close the right door 7, first sit in the driver seat 3 inside the automobile 1, then move from the driver seat 3 to the front passenger seat 4, and sit in the front passenger seat 4. When exiting the automobile 1, the front passenger may first move from the front passenger seat 4 to the driver seat 3, open and close the right door 7 in the driver seat 3, and exit the automobile 1.

Thus, for example, there are cases where the parking space of the automobile 1 is small. There are also cases where another automobile in an adjacent parking space is parked near a borderline between the parking spaces. In such cases, it is sometimes difficult to secure an external space for opening and closing the right door 7 or the left door 9 on a right outer side or the left outer side of the automobile 1. When the size of the parking space is small, the driver and the front passenger may be unable to open and close their respective doors.

In the vehicle cabin of the automobile 1, the console box 5 is provided between the driver seat 3 and the front passenger seat 4. The console box 5 may be, for example, of a box structure for storing personal belongings of occupants. The console box 5 may be raised above the seating surface of the driver seat 3 and the seating surface of the front passenger seat 4 for convenience during a ride etc. A front surface of the console box 5 is sometimes protruded frontward beyond a front end of the seating surface of the driver seat 3 and a front end of the seating surface of the front passenger seat 4.

The driver or the front passenger who tries to move between the driver seat 3 and the front passenger seat 4 to enter or exit from the side of a seat of the automobile 1 that is not the seat in which the driver or the front passenger has been seated may be hindered from moving between the seats by the console box 5. This is because the console box 5 is protruded between the driver seat 3 and the front passenger seat 4. Hereinafter, the side of the seat that is not the seat in which one has been seated will be also referred to as the opposite side of the automobile 1. As a result, the driver or the front passenger who tries to enter or exit from the opposite side of the automobile 1 may move inside the vehicle while folding their legs inside the vehicle so as to avoid the protruding console box 5. In some cases, the driver and the front passenger may move between the seats in a posture with their upper bodies bent down, after holding their legs by hand and bringing their legs to the opposite side of the console box 5 provided so as to protrude. When a child is seated in the front passenger seat 4, the child may move between the seats while walking over the seat with his or her shoes on or crawling over the seat to move to the opposite side of the protruding console box 5. In any case, due to the protruding console box 5, it may take effort for the driver and the front passenger to move between the seats. If the driver or the front passenger is an elderly person, the above-described movement between the seats may be a huge burden. Thus, the automobile 1 has room for improvement in terms of reducing the effort taken for the driver or the front passenger to enter or exit the automobile 1.

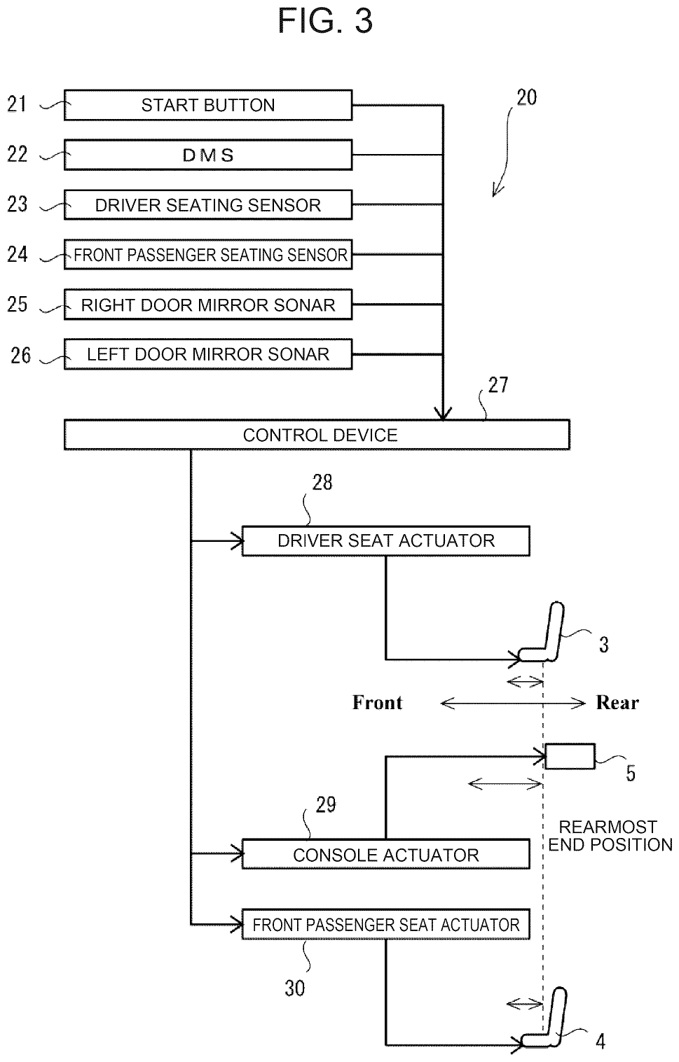

FIG. 3 is an explanatory view of main components of an exit assistance device 20 of the automobile 1 of FIG. 1. The exit assistance device 20 of the automobile 1 of FIG. 3 has the start button 21, a driver monitoring system (DMS) 22, a driver seating sensor 23, a front passenger seating sensor 24, a right door mirror sonar 25, a left door mirror sonar 26, and a control device 27 to which these components are coupled. To the control device 27, a driver seat actuator 28, a console actuator 29, and a front passenger seat actuator 30 are further coupled.

The start button 21 is an operation button for turning the travelable state of the automobile 1 on or off. When the start button 21 is in an on state, the automobile 1 is in the travelable state. When the start button 21 is in an off state, the automobile 1 is in the untravelable state. Here, the travelable state refers to a state where, when the driver operates the accelerator pedal, for example, the automobile I can travel accordingly. The start button 21 outputs a signal indicating its operated state to the control device 27.

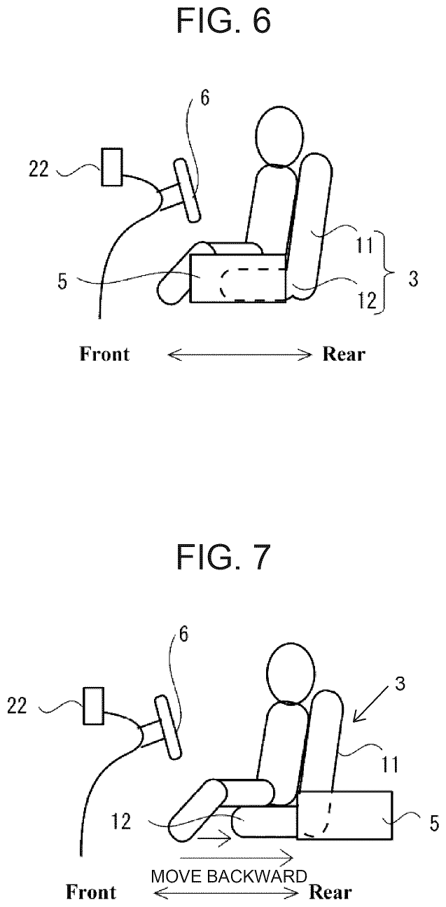

As illustrated in FIG. 6 to be described later, the DMS 22 is provided at an upper part of a dashboard panel so as to be oriented to a rear side in a front-rear direction of the automobile 1. The DMS 22 has a camera that images the driver and the front passenger, and recognizes occupants seated in the seats and outputs recognition information to the control device 27.

The driver seating sensor 23 is a pressure senser provided in the seating surface of the driver seat 3. When, for example, a driver is seated in the driver seat 3, the driver seating sensor 23 outputs a detection signal indicating that a driver is seated to the control device 27.

The front passenger seating sensor 24 is a pressure sensor provided in the seating surface of the front passenger seat 4. When, for example, a front passenger is seated in the front passenger seat 4, the front passenger seating sensor 24 outputs a detection signal indicating that a front passenger is seated to the control device 27.

The left door mirror sonar 26 is provided on the left door mirror 10. The left door mirror sonar 26 detects a detection range A on an outer side of the closed left door 9 as indicated by the dashed-line ellipse in FIG. 2. The detection range A includes a range of a trajectory of the left door 9 being opened and closed. When there is an object that constitutes an obstacle to opening and closing the left door 9 in the detection range A, the left door mirror sonar 26 outputs a detection signal of that obstacle to the control device 27. Thus, the left door mirror sonar 26 can detect an obstacle outside the vehicle within the opening-closing range of the left door 9 that is opened and closed when an occupant gets into and out of the front passenger seat 4 of the automobile 1.

The right door mirror sonar 25 is provided on the right door mirror 8. As with the left door mirror sonar 26, the right door mirror sonar 25 detects a detection range on an outer side of the closed right door 7. The detection range includes a range of a trajectory of the right door 7 being opened and closed. When there is an object that constitutes an obstacle to opening and closing the right door 7 in the detection range, the right door mirror sonar 25 outputs a detection signal of that obstacle to the control device 27. Thus, the right door mirror sonar 25 can detect an obstacle outside the vehicle within the opening-closing range of the right door 7 that is opened and closed when an occupant gets into and out of the driver seat 3 of the automobile 1.

The driver seat actuator 28 is an actuator that drives a front-rear position of the driver seat 3. As illustrated in FIG. 3, the position of the driver seat 3 can be moved in the front-rear direction of the automobile 1. The driver can drive the automobile 1 in an optimal driving position by adjusting the position of the driver seat 3 frontward and backward according to his or her own body size. For example, based on stored information on the position of the driver seat 3 for each driver that has been recognized by the DMS 22, the driver seat actuator 28 may drive the position of the driver seat 3 frontward or backward so as to set the driver seat 3 at the position according to the stored information. Thus, in the embodiment, the driver seat actuator 28 serves as a second actuator that moves the driver seat 3 backward toward a rear side in the front-rear direction of the automobile 1.

The front passenger seat actuator 30 is an actuator that drives the front-rear position of the front passenger seat 4. As illustrated in FIG. 3, the position of the front passenger seat 4 can be moved in the front-rear direction of the automobile 1. The front passenger can ride the automobile 1 in an optimal riding posture by adjusting the position of the front passenger seat 4 frontward and backward according to his or her own body size. For example, based on stored information on the position of the front passenger seat 4 for each front passenger that has been recognized by the DMS 22, the front passenger seat actuator 30 may drive the position of the front passenger seat 4 frontward and backward so as to set the front passenger seat 4 to the position according to the stored information. Thus, in the embodiment, the front passenger seat actuator 30 serves as a third actuator that moves the front passenger seat 4 backward toward the rear side in the front-rear direction of the automobile 1.

The console actuator 29 is an actuator that drives the front-rear position of the console box 5. In the embodiment, the console actuator 29 serves as a first actuator. The front-rear position of the console box 5 may be adjustable for the aforementioned convenience during a ride etc. Thus, the driver and the front passenger can adjust the front-rear position of the console box 5 according to their body sizes etc. Some drivers adjust the front-rear position of the console box 5 such that the console box 5 protrudes frontward beyond the front end of the seating surface of the driver seat 3. Thus, the console box 5 can be positioned so as to be easy to use during driving. Other drivers adjust the console box 5 to a rear end in the front-rear direction such that the console box 5 does not get in the way during driving. To achieve these different types of convenience, the console box 5 may be provided so as to be adjustable within a wider range than front-rear adjustment ranges of the driver seat 3 and the front passenger seat 4.

The control device 27 receives input information, such as detection signals, from the above-described components. The control device 27 determines entry and exit of the driver and the front passenger based on the input information, and outputs control signals to the driver seat actuator 28, the console actuator 29, and the front passenger seat actuator 30. The control device 27 serves as a controller that controls the driver seat actuator 28, the console actuator 29, and the front passenger seat actuator 30.

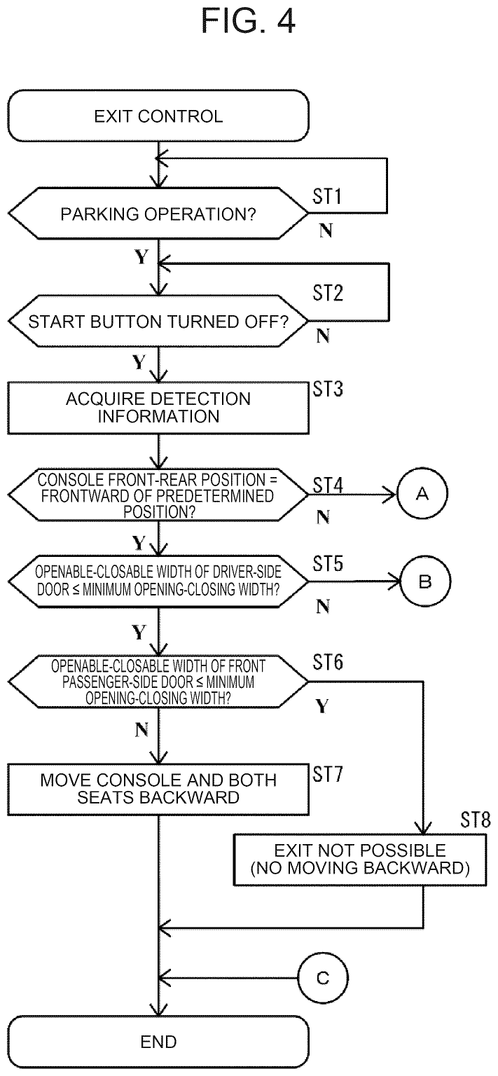

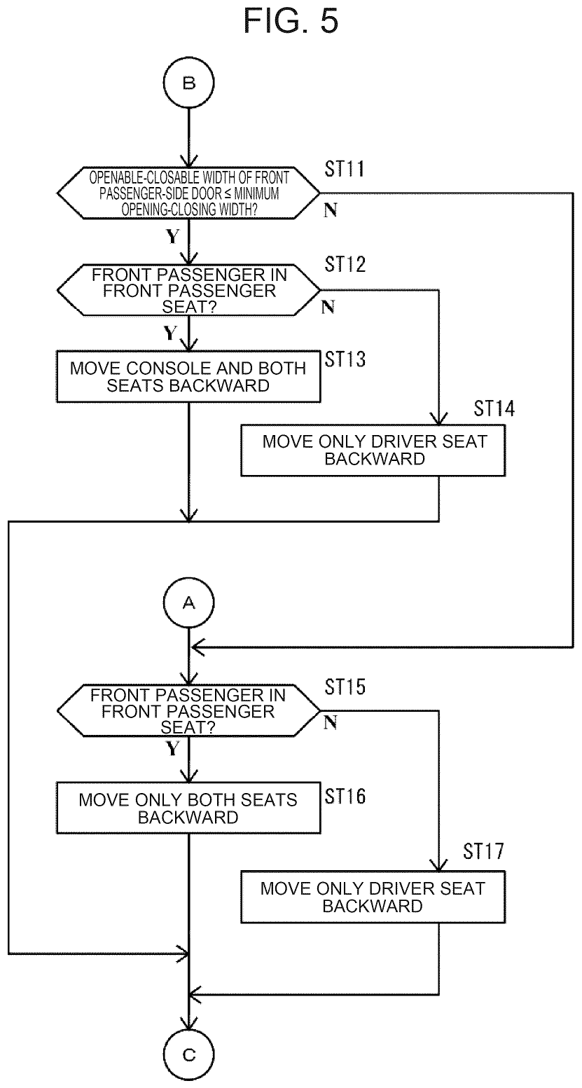

FIG. 4 is a flowchart of a main process of exit control for the driver and the front passenger by the control device 27 of FIG. 3. FIG. 5 is a flowchart of the rest of the process of the exit control of FIG. 4. A to C in FIG. 4 and FIG. 5 are connection points between the flowcharts. The control device 27 repeatedly executes the exit control of FIG. 4 and FIG. 5.

In step ST1, the control device 27 determines whether a parking operation of the automobile 1 has been performed. After parking the automobile 1 in a parking space, the driver operates a shift lever (not illustrated) to a parking position and operates a side brake. When these driver's operations have not been performed, the control device 27 determines that the parking operation of the automobile 1 has not been performed, and repeats the current process. When these driver's operations have been performed, the control device 27 determines that the parking operation of the automobile 1 has been performed, and moves the process to step ST2.

In step ST2, the control device 27 further determines whether the start button 21 has been turned off. When the driver exits the automobile 1 having been parked in the parking space, the driver turns off the start button 21 that is in the on state. When the start button 21 has not been turned off, the control device 27 repeats the current process. When the start button 21 is turned off, the control device 27 moves the process to step ST3.

In step ST3, the control device 27 acquires current detection information from the automobile 1.

In step ST4, the control device 27 determines whether the front-rear position of the console box 5 is protruded frontward beyond a predetermined position. As described above, the driver has adjusted the front-rear position of the console box 5 so as to be easy to use during driving. When the front-rear position of the console box 5 is protruded frontward beyond the predetermined position in a front-rear adjustment range of the console box 5, the console box 5 gets in the way of the driver and the front passenger moving between the seats. For example, when the front surface of the console box 5 is protruded frontward beyond the front end of the driver seat 3 and the front end of the front passenger seat 4, the movement of the driver or the front passenger when they move between the seats may be hindered. The control device 27 may determine whether the front-rear position of the console box 5 is protruded frontward of the predetermined position at which the console box 5 may thus get in the way of the movement of the driver and the front passenger. When the front-rear position of the console box 5 is protruded frontward of the predetermined position, the control device 27 moves the process to step ST5. On the other hand, when the front-rear position of the console box 5 is not protruded frontward of the predetermined position, the control device 27 moves the process to step ST15.

In step ST5, the control device 27 determines whether the right door 7 is openable and closable so as to allow entry and exit based on detection by the right door mirror sonar 25. For example, the control device 27 determines whether an openable-closable width when the closed right door 7, which is the driver-side door, opens toward the outer side of the vehicle is equal to or smaller than a minimum opening-closing width. Here, the openable-closable width for a space outside the closed right door 7 may be a distance between an outer surface of the closed right door 7 and a nearby obstacle as illustrated by the example of a separation distance L in FIG. 2. The minimum opening-closing width may be, for example, an opening width of the right door 7 that allows the driver and the front passenger to enter and exit by slipping through between the open right door 7 and the vehicle body 2. In the embodiment, the minimum opening-closing width may be a width when the door is fully opened, or may instead be, for example, a width when the door is opened such that the thickness of the body size of an average occupant can be secured between the open door and the vehicle body 2. In this case, the minimum opening-closing width may be, for example, 40 centimeters. The control device 27 may detect the body sizes of the driver and the front passenger who are riding the vehicle by the driver seating sensor 23 and the front passenger seating sensor 24 provided in the driver seat 3 and the front passenger seat 4, the DMS 22, etc. The control device 27 may select, from among a plurality of minimum opening-closing widths according to the detected body sizes, a minimum opening-closing width that allows an occupant with the largest body size to enter and exit as one to be used in determining whether the openable-closable width is equal to or smaller than the minimum opening-closing width. The control device 27 may determine whether the right door 7 is openable and closable so as to allow entry and exit based on an image of an external camera (not illustrated) etc. of the automobile 1. For example, when there is no obstacle to opening and closing the right door 7 in the detection range of the right door mirror sonar 25, the control device 27 determines that the openable-closable width when the right door 7, which is the driver-side door, opens toward the outer side of the vehicle is not equal to or smaller than the minimum opening-closing width, and moves the process to step ST11. On the other hand, when there is an obstacle at a position within the minimum opening-closing width, the control device 27 determines that the openable-closable width when the right door 7, which is the driver-side door, opens toward the outer side of the vehicle is equal to or smaller than the minimum opening-closing width, and moves the process to step ST6.

In step ST6, the control device 27 determines whether the left door 9 is openable and closable so as to allow entry and exit based on detection by the left door mirror sonar 26. For example, the control device 27 determines whether an openable-closable width when the closed left door 9, which is the front passenger-side door, opens toward the outer side of the vehicle is equal to or smaller than a minimum opening-closing width. Here, a front passenger-side external width in a space outside the closed left door 9 refers to a distance between an outer surface of the closed left door 9 and a nearby obstacle like L in FIG. 2. The minimum opening-closing width may be, for example, an opening width of the left door 9 that allows the driver and the front passenger to enter and exit by slipping through between the open left door 9 and the vehicle body 2. The control device 27 may determine whether the left door 9 is openable and closable so as to allow entry and exit based on an image of an external camera (not illustrated) etc. of the automobile 1. For example, when there is no obstacle to opening and closing the left door 9 in the detection range of the left door mirror sonar 26, the control device 27 determines that the openable-closable width when the closed left door 9, which is the front passenger-side door, opens toward the outer side of the vehicle is not equal to or smaller than the minimum opening-closing width, and moves the process to step ST7. On the other hand, when there is an obstacle at a position within the minimum opening-closing width, the control device 27 determines that the openable-closable width when the closed left door 9, which is the front passenger-side door, opens toward the outer side of the vehicle is equal to or smaller than the minimum opening-closing width, and moves the process to step ST8.

In this way, the control device 27 first determines whether the right door 7 is openable and closable so as to allow entry and exit. When the right door 7 is not openable and closable so as to allow entry and exit, the control device 27 further determines whether the left door 9 is openable and closable so as to allow entry and exit. By performing the determinations in this order, as illustrated in FIG. 4 and FIG. 5, the control device 27 can facilitate the case-by-case process according to the possibility of opening and closing the right door 7 and the left door 9.

Step ST7 is a process for a case where the right door 7 is not openable and closable so as to allow entry and exit and the left door 9 is openable and closable so as to allow entry and exit. The control device 27 executes this process when the console box 5 is protruded frontward beyond the driver seat 3 and the front passenger seat 4. In this case, the control device 27 moves both the driver seat 3 and the front passenger seat 4 backward along with the console box 5. The control device 27 outputs a driving signal for moving backward to the driver seat actuator 28 and the front passenger seat actuator 30. Accordingly, the driver seat 3 and the front passenger seat 4 move backward to rearmost end positions in the adjustment ranges of the respective seats of FIG. 3. The control device 27 outputs a driving signal for moving backward to the console actuator 29. Accordingly, the console box 5 moves backward to a rearmost end position in the adjustment range of the console box 5 of FIG. 3. As illustrated in FIG. 3, the front surface of the console box 5 having moved backward to the rearmost end position moves backward until it becomes substantially flush with a front end of a seatback 11 of the driver seat 3 and a front end of a seatback 11 of the front passenger seat 4, both seats having moved backward to the rearmost end positions. The control device 27 need not move the driver seat 3 and the front passenger seat 4 backward to the rearmost end positions of the respective seats. In this case, the control device 27 need not move the console box 5 backward to the rearmost position of the console box 5 either. The control device 27 moves the console box 5 backward until it becomes substantially flush with the front end of the seatback 11 of the driver seat 3 and the front end of the seatback 11 of the front passenger seat 4, both seats having moved backward. Thereafter, the control device 27 ends the current control.

FIG. 6 is an explanatory view of the position of the driver seat 3 and the position of the console box 5 when the driver is in a driving position. FIG. 7 is an explanatory view of the position of the driver seat 3 and the position of the console box 5 when the driver and the front passenger exit. The driver seat 3 has a seat seating surface 12 and the seatback 11 erected with respect to the seat seating surface 12.

As illustrated in FIG. 6, when making the automobile 1 travel, the driver moves the driver seat 3 frontward to achieve the driving position. In FIG. 6, the driver has adjusted the front-rear position of the console box 5 such that the front surface of the console box 5 is protruded frontward beyond the front end of the seating surface of the driver seat 3. In this case, the control device 27 determines in step ST4 that the front-rear position of the console box 5 is protruded frontward beyond the predetermined position. Then, the control device 27 executes the process of step ST7 after the determinations of step ST5 and step ST6. Accordingly, as illustrated in FIG. 7, the driver seat 3 moves backward to the rearmost end position in the adjustment range. The front passenger seat 4 also moves backward to the rearmost end position in the adjustment range. The console box 5 moves backward to the rearmost end position in the adjustment range. The front surface of the console box 5 having moved backward to the rearmost end position moves backward until it becomes substantially flush with the front end of the seatback 11 of the driver seat 3 and the front end of the seatback 11 of the front passenger seat 4, both seats having moved backward to the rearmost end positions.

In the state of FIG. 7, since the driver seat 3 has moved backward, a larger space compared with that in FIG. 6 is provided between the driver seat 3 and the steering wheel 6. A legroom in front of the driver seat 3 is also large. Since the front passenger seat 4 has also moved backward, a large space is provided in front of the front passenger seat 4. A legroom in front of the front passenger seat 4 is also large. Further, the console box 5 is not protruded frontward beyond the front end of the seatback 11 of the driver seat 3 and the front end of the seatback 11 of the front passenger seat 4. Therefore, the driver seated in the driver seat 3 can move his or her upper body onto the front passenger seat 4 by laterally moving his or her hips from the driver seat 3 to the front passenger seat 4. In addition, the driver can move his or her lower limbs to the front of the front passenger seat 4 by drawing his or her legs closer to himself or herself with his or her hips seated in the front passenger seat 4. When moving from the driver seat 3 to the front passenger seat 4, the driver can move easily without crossing over the console box 5 in an unnatural posture. Using the large legroom created as these three move backward, the driver can move easily in a direction perpendicular to the sheet plane of FIG. 7, i.e., from the driver seat 3 to the front passenger scat 4.

Step ST8 of FIG. 4 is a process for a case where the right door 7 is not openable and closable so as to allow entry and exit and the left door 9 is not openable and closable so as to allow entry and exit. The control device 27 executes this process when the console box 5 is protruded frontward beyond the driver seat 3 and the front passenger seat 4. In this case, since exit from the automobile 1 is not possible, the control device 27 does not move the console box 5, the driver seat 3, and the front passenger seat 4 backward. Thereafter, the control device 27 ends the current control.

Thus, when both the right door 7 and the left door 9 are in a state of being not appropriately openable and closable and exit from the automobile 1 is not possible, the control device 27 does not move the console box 5, the driver seat 3, and the front passenger seat 4 backward. The control device 27 does not output the driving signals to the console actuator 29, the driver seat actuator 28, and the front passenger seat actuator 30. As a result, as the console box 5 etc. do not move backward, the driver can easily grasp that the door cannot be appropriately opened and closed to exit. The driver can take action to exit.

Step ST11 of FIG. 5 is a process for a case where the right door 7 is openable and closable so as to allow entry and exit. Step ST11 is a process for a case where the left door 9 is not openable and closable so as to allow entry and exit. The control device 27 determines, for example, whether the openable-closable width when the closed left door 9, which is the front passenger-side door, opens toward the outer side of the vehicle is equal to or smaller than the minimum opening-closing width. For example, when there is no obstacle to opening and closing the left door 9 in the detection range of the left door mirror sonar 26, the control device 27 determines that the openable-closable width when the closed left door 9, which is the front passenger-side door, opens toward the outer side of the vehicle is not equal to or smaller than the minimum opening-closing width, and moves the process to step ST15. On the other hand, when there is an obstacle at a position within the minimum opening-closing width, the control device 27 determines that the openable-closable width when the closed left door 9, which is the front passenger-side door, opens toward the outer side of the vehicle is equal to or smaller than the minimum opening-closing width, and moves the process to step ST12.

In step ST12, the control device 27 determines whether a front passenger is seated in the front passenger seat 4. The control device 27 may determine whether a front passenger is seated in the front passenger seat 4 based on a detection signal of the front passenger seating sensor 24. Alternatively, the control device 27 may determine whether a front passenger is seated in the front passenger seat 4 based on detection of a front passenger in the front passenger seat 4 by the DMS 22. When a front passenger is seated in the front passenger seat 4, the control device 27 moves the process to step ST13. When a front passenger is not seated in the front passenger seat 4, the control device 27 moves the process to step ST14. Thus, when the right door 7 is openable and closable so as to allow entry and exit, the control device 27 further determines whether the left door 9 is openable and closable so as to allow entry and exit and whether there is an occupant in the front passenger seat 4 provided in the automobile 1.

Step ST13 is a process for a case where the right door 7 is openable and closable so as to allow entry and exit and the left door 9 is not openable and closable so as to allow entry and exit. The control device 27 executes this process when the console box 5 is protruded frontward beyond the driver seat 3 and the front passenger seat 4. In this case, the control device 27 moves both seats of the driver seat 3 and the front passenger seat 4 backward along with the console box 5. The control device 27 outputs the driving signal for moving backward to the driver seat actuator 28 and the front passenger seat actuator 30. Accordingly, the driver seat 3 and the front passenger seat 4 move backward to the positions of the rearmost ends in the adjustment ranges. The control device 27 outputs the driving signal for moving backward to the console actuator 29. Accordingly, the console box 5 moves backward to the rearmost end position in the adjustment range. As illustrated in FIG. 3, the front surface of the console box 5 having moved backward to the rearmost end position moves backward until it becomes substantially flush with the front end of the seatback 11 of the driver seat 3 and the front end of the seatback 11 of the front passenger seat 4, both seats having moved backward to the rearmost end positions. Thereafter, the control device 27 ends the current control.

As a result of the process of step ST13, the driver seat 3, the front passenger seat 4, and the console box 5 have moved backward as in FIG. 7. The console box 5 is not protruded frontward beyond the front end of the seatback 11 of the driver seat 3 and the front end of the seatback 11 of the front passenger seat 4. Therefore, the front passenger seated in the front passenger seat 4 can move his or her upper body onto the driver seat 3 by laterally moving his or her hips from the front passenger seat 4 to the driver seat 3. The front passenger can move his or her lower limbs to the front of the driver seat 3 by drawing his or her legs closer to himself or herself with his or her hips seated in the driver seat 3. When moving from the front passenger seat 4 to the driver seat 3 in a direction perpendicular to the sheet plane of FIG. 7, the front passenger can move easily without crossing over the console box 5 in an unnatural posture. Using the large legroom created as these three move backward, the front passenger can move easily from the front passenger seat 4 to the driver seat 3. A child seated in the front passenger seat 4 can move easily from the front passenger seat 4 to the driver seat 3 using the large legroom without walking over the seat or crawling to move to the opposite side of the protruding console box 5.

Step ST14 is a process for a case where a front passenger is not seated in the front passenger seat 4. In this case, the control device 27 moves only the driver seat 3 backward among the console box 5, the driver seat 3, and the front passenger seat 4. The control device 27 outputs the driving signal for moving backward to the driver seat actuator 28. Accordingly, the driver seat 3 moves backward to the rearmost end position in the adjustment range. The control device 27 does not output the driving signals for moving backward to the front passenger seat actuator 30 and the console actuator 29. Accordingly, the front passenger seat 4 and the console box 5 remain at the front-rear positions set during travel. Thereafter, the control device 27 ends the current control.

As a result of the process of step ST14, the driver seat 3 moves backward as in FIG. 7. However, the console box 5 remains at the position in FIG. 6. The driver seated in the driver seat 3 can exit the automobile 1 by opening the right door 7 in a state of being seated in the driver seat 3.

Step ST15 is a process for a case where the right door 7 is openable and closable so as to allow entry and exit and the left door 9 is openable and closable so as to allow entry and exit. The control device 27 executes this process when it is determined in step ST4 that the front-rear position of the console box 5 is not protruded frontward beyond the predetermined position. The control device 27 determines whether a front passenger is seated in the front passenger seat 4. The control device 27 may determine whether a front passenger is seated in the front passenger seat 4 based on the detection signal of the front passenger seating sensor 24. Alternatively, the control device 27 may determine whether a front passenger is seated in the front passenger seat 4 based on detection of a front passenger in the front passenger seat 4 by the DMS 22. When a front passenger is seated in the front passenger seat 4, the control device 27 moves the process to step ST16. When a front passenger is not seated in the front passenger seat 4, the control device 27 moves the process to step ST17. Thus, when the console box 5 is not protruded frontward beyond the driver seat 3 and the front passenger seat 4, the control device 27 determines whether there is an occupant in the front passenger seat 4 provided in the automobile 1.

Step ST16 is a process for a case where a front passenger is seated in the front passenger seat 4. In addition, this process is a process for a case where the right door 7 is openable and closable so as to allow entry and exit and the left door 9 is openable and closable so as to allow entry and exit. In this case, the control device 27 moves the driver seat 3 and the front passenger seat 4 backward regardless of the front-rear position of the console box 5. The control device 27 does not move the console box 5 backward. The control device 27 outputs the driving signals for moving backward to the driver seat actuator 28 and the front passenger seat actuator 30. Accordingly, the driver seat 3 and the front passenger seat 4 move backward to the rearmost end positions in the adjustment ranges. The control device 27 does not output the driving signal for moving backward to the console actuator 29. Accordingly, the console box 5 remains at the front-rear position set during travel. Thereafter, the control device 27 ends the current control.

As a result of the process of step ST16, the driver seat 3 moves backward as in FIG. 7. The front passenger seat 4 also moves backward. The driver seated in the driver seat 3 can exit the automobile 1 using the enlarged legroom by opening the right door 7 in the state of being seated in the driver seat 3. The front passenger seated in the front passenger seat 4 can exit the automobile I using the enlarged legroom by opening the left door 9 in the state of being seated in the front passenger seat 4. Moreover, since at least an upper part of the console box 5 has not moved backward, the driver and the front passenger can easily recognize that they need not enter or exit from their respective opposite sides, and can easily exit from their respective nearby doors.

Step ST17 is a process for a case where a front passenger is not seated in the front passenger seat 4. In addition, this process is a process for a case where the right door 7 is openable and closable so as to allow entry and exit and the left door 9 is openable and closable so as to allow entry and exit. In this case, the control device 27 moves only the driver seat 3 backward regardless of the front-rear position of the console box 5. The control device 27 does not move the front passenger seat 4 and the console box 5 backward. The control device 27 outputs the driving signal for moving backward to the driver seat actuator 28. Accordingly, the driver seat 3 moves backward to the rearmost end position in the adjustment range. The control device 27 does not output the driving signals for moving backward to the front passenger seat actuator 30 and the console actuator 29. Accordingly, the front passenger seat 4 and the console box 5 remain at the front-rear positions set during travel. Thereafter, the control device 27 ends the current control.

As a result of the process of step ST17, the driver seat 3 moves backward as in FIG. 7. The driver seated in the driver seat 3 can exit the automobile 1 using the enlarged legroom by opening the right door 7 in the state of being seated in the driver seat 3. Moreover, since the at least an upper part of the console box 5 does not move backward, the driver can easily recognize that the driver need not enter or exit from the opposite side, and can easily enter or exit from the nearby right door 7.

As has been described above, in the embodiment, while the automobile 1 is stationary, the control device 27 determines whether the right door 7 is openable and closable so as to allow entry and exit based on detection by the right door mirror sonar 25 and whether the left door 9 is openable and closable so as to allow entry and exit based on detection by the left door mirror sonar 26. When the right door 7 is not openable and closable so as to allow entry and exit, the control device 27 moves the console box 5 backward toward the rear side in the front-rear direction by the console actuator 29. As the console box 5 has moved backward toward the rear side in the front-rear direction, the driver can move easily from the driver seat 3 to the front passenger seat 4. The driver can move easily from the driver seat 3 to the front passenger seat 4 without folding his or her legs inside the vehicle so as to avoid the protruding console box 5. When the left door 9 is not openable and closable so as to allow entry and exit, the control device 27 moves the console box 5 backward toward the rear side in the front-rear direction by the console actuator 29. As the console box 5 has moved backward toward the rear side in the front-rear direction, the front passenger can move easily from the front passenger seat 4 to the driver seat 3. The front passenger can move easily from the front passenger seat 4 to the driver seat 3 without folding his or her legs inside the vehicle so as to avoid the protruding console box 5.

Thus, according to this disclosure, effort taken for the driver or the front passenger to enter or exit from the opposite side of the automobile I can be reduced.

In the embodiment, the control device 27 moves the console box 5 backward toward the rear side in the front-rear direction of the automobile 1 such that the front end of the console box 5 to be moved backward is located rearward of the front end of the seatback 11 of the driver seat 3 and the front end of the seatback 11 of the front passenger seat 4. Thus, the console box 5 assumes a state of not protruding between the driver seat 3 and the front passenger seat 4. The driver and the front passenger can move easily between the driver seat 3 and the front passenger seat 4 by shifting their hips between the driver seat 3 and the front passenger seat 4.

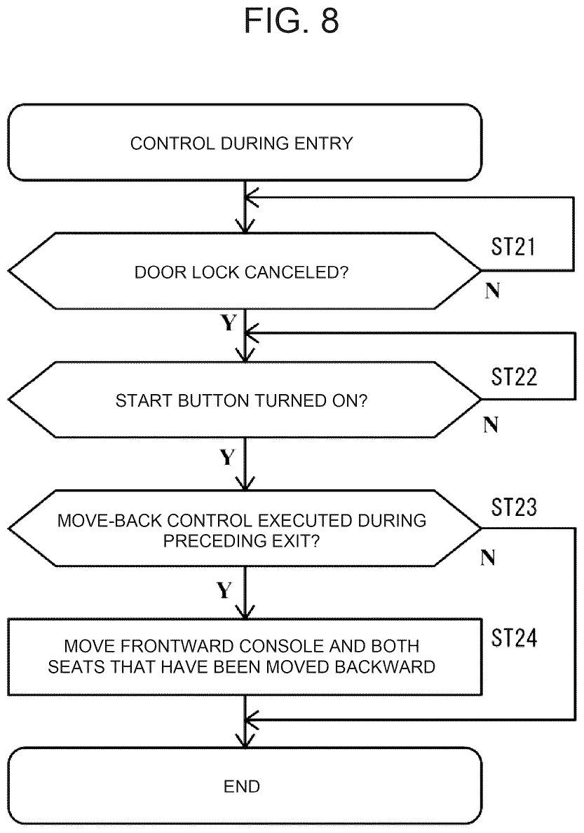

Next, control during entry will be described. FIG. 8 is a flowchart of a main process of the control during entry of the driver and the front passenger by the control device 27 of FIG. 3. The control device 27 repeatedly executes the control during entry of FIG. 8.

In step ST21, the control device 27 determines whether a door lock of the locked automobile 1 has been canceled. When the door lock has not been canceled, the control device 27 repeats the current process. When the door lock is canceled, the control device 27 moves the process to step ST22.

In step ST22, the control device 27 determines whether the start button 21 of the automobile 1 in the off state has been turned on. When the start button 21 has not been turned on, the control device 27 repeats the current process. When the start button 21 is turned on, the control device 27 moves the process to step ST23.

In step ST23, the control device 27 determines whether the move-back control has been executed for one or more of the console box 5, the driver seat 3, and the front passenger seat 4 in the exit control of FIG. 4 and FIG. 5 during the preceding exit. For example, when the process of step ST7, step ST13, step ST14, step ST16, or step ST17 has been executed in the preceding exit control of FIG. 4 and FIG. 5, the control device 27 determines that the move-back control has been executed during the preceding exit. Then, the control device 27 moves the process to step ST24. On the other hand, when the process of step ST8 has been executed in the preceding exit control of FIG. 4 and FIG. 5, the control device 27 determines that the move-back control has not been executed during the preceding exit. The control device 27 ends the current control.

In step ST24, the control device 27 executes move-forth control for returning one or more of the console box 5, the driver seat 3, and the front passenger seat 4 that have been moved backward during the preceding exit to their front-rear positions before having been moved backward. The control device 27 outputs a driving signal for moving frontward to one or more of the console actuator 29, the driver seat actuator 28, or the front passenger seat actuator 30. Accordingly, the one or more of the console box 5, the driver seat 3, and the front passenger seat 4 that have been moved backward during the preceding exit return to their front-rear positions before the move-back control during the preceding exit. For example, the console box 5 and the driver seat 3 return from the front-rear positions having been moved backward in FIG. 7 to the front-rear positions for the driving position in FIG. 6.

As has been described above, in the embodiment, when the start button 21 for putting the automobile 1 in the travelable state is turned on, the control device 27 moves frontward the one or more of the console box 5, the driver seat 3, and the front passenger seat 4 that have been moved backward. Since the console box 5 etc. are thus moved frontward at the timing of turning on of the start button 21 for putting the automobile 1 in the travelable state, when the driver or the front passenger enters the automobile 1, the console box 5 etc. are maintained at the same front-rear positions that have been moved backward. As the console box 5 etc. have moved backward, the driver or the front passenger can enter the automobile 1 and move easily between the seats.

On the other hand, there is a case, for example, where the one or more of the console box 5, the driver seat 3, and the front passenger seat 4 that have been moved backward are moved frontward at the timing of canceling of the door lock in step ST21 of FIG. 8. In this case, the driver or the front passenger may move between the seats so as to cross over the console box 5 etc. that have returned to their original positions before entry. That is, when entering from the door on the opposite side, the driver or the front passenger may move so as to cross over the console box 5 that is protruded between the driver seat 3 and the front passenger seat 4.

While the above-described embodiment is an example of preferred embodiments of the disclosure, the disclosure is not limited thereto and various modifications or changes are possible within such a range that no departure is made from the gist of the disclosure.

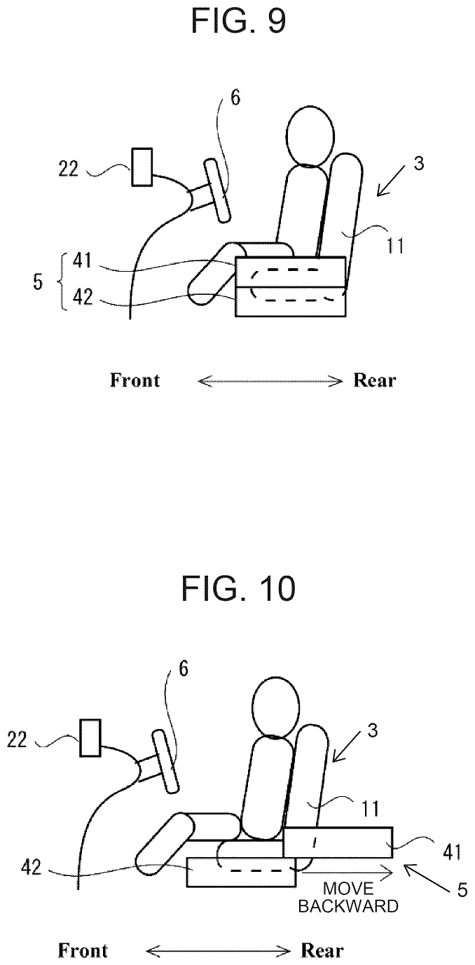

FIG. 9 is an explanatory view of a console box 5 according to a modified example of the above-described embodiment that is divided into upper and lower halves. The console box 5 of FIG. 9 has a lower member 42 that constitutes a lower part of the console box 5 and an upper member 41 that is slidable in the front-rear direction over the lower member 42.

The lower member 42 is fixedly provided at a position between the driver seat 3 and the front passenger seat 4. An upper edge of the lower member 42 is below the seating surface of the driver seat 3 and the seating surface of the front passenger seat 4. In this case, the console actuator 29 drives the front-rear position of the upper member 41 of the console box 5.

FIG. 10 is an explanatory view of a state where the upper member 41 of the console box 5 divided into the upper and lower halves of FIG. 9 has moved farthest backward with respect to the lower member 42 of the console box 5. In FIG. 10, the driver seat 3 has also moved backward from the position in FIG. 9. In the process of step ST7 of FIG. 4 and step ST13 of FIG. 5, the control device 27 moves the upper member 41 of the console box 5 backward along with both seats of the driver seat 3 and the front passenger seat 4. Thus, the console box 5 moves backward to the position of a rearmost end in an adjustment range. A front surface of the upper member 41 of the console box 5 having moved backward to the rearmost end position moves backward until it becomes substantially flush with the front end of the seatback 11 of the driver seat 3 and the front end of the seatback 11 of the front passenger seat 4, both seats having moved backward to the rearmost end positions.

Also in the case of this modified example, at least the upper member 41 that is a part of the console box 5 moves backward. The upper member 41 of the console box 5 having moved backward is not protruded between the driver seat 3 and the front passenger seat 4 having moved backward. As a result, the driver can move easily from the driver seat 3 to the front passenger seat 4. The driver can move easily from the driver seat 3 to the front passenger seat 4 without folding his or her legs inside the vehicle so as to avoid the protruding console box 5. The front passenger can move easily from the front passenger seat 4 to the driver seat 3. The front passenger can move easily from the front passenger seat 4 to the driver seat 3 without folding his or her legs inside the vehicle so as to avoid the protruding console box 5.

The control device 27 illustrated in FIG. 3 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control device 27 illustrated in FIG. 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control device illustrated in FIG. 3.

What is claimed is:

1. An exit assistance device of a vehicle, the exit assistance device comprising:
a console member provided between a driver seat and a front passenger seat in a vehicle cabin of the vehicle;
a first actuator configured to move at least an upper part of the console member backward toward a rear side in a front-rear direction of the vehicle;
a controller configured to control the first actuator;
a driver-side sensor configured to detect an obstacle outside the vehicle within an opening-closing range of a driver's door configured to open and close when an occupant gets into or out of the driver seat; and
a front passenger-side sensor configured to detect an obstacle outside the vehicle within an opening-closing range of a front passenger's door configured to open and close when an occupant gets into or out of the front passenger seat, wherein the controller is configured to:
while the vehicle is stationary, determine whether the driver's door is openable and closable based on the detection by the driver-side sensor, and determine whether the front passenger's door is openable and closable based on the detection by the front passenger-side sensor; and
when the controller determines that the driver's door is not openable and closable or when the controller determines that the front passenger's door is not openable and closable, move the at least an upper part of the console member backward toward the rear side in the front-rear direction of the vehicle by controlling the first actuator.

2. The exit assistance device according to claim 1, wherein the controller is configured to:
determine whether the driver's door is openable and closable;
when the controller determines that the driver's door is not openable and closable, determine whether the front passenger's door is openable and closable;
when the controller determines that the front passenger's door is openable and closable, move the at least an upper part of the console member backward toward the rear side in the front-rear direction of the vehicle by controlling the first actuator; and
when the controller determines that the front passenger's door is not openable and closable, not move the at least an upper part of the console member backward toward the rear side in the front-rear direction of the vehicle.

3. The exit assistance device according to claim 2, further comprising:
a second actuator configured to move the driver seat backward toward the rear side in the front-rear direction of the vehicle; and
a third actuator configured to move the front passenger seat backward toward the rear side in the front-rear direction of the vehicle, wherein the controller is configured to:
when the controller determines that the driver's door is not openable and closable and that the front passenger's door is openable and closable, move the driver seat and the front passenger seat backward toward the rear side in the front-rear direction of the vehicle along with the at least an upper part of the console member by controlling the first actuator, the second actuator, and the third actuator; and
when the controller determines that the driver's door is not openable and closable and that the front passenger's door is not openable and closable, not move the driver seat and the front passenger seat backward toward the rear side in the front-rear direction of the vehicle along with the at least an upper part of the console member.

4. The exit assistance device according to claim 3, wherein the controller is configured to:
when the controller determines that the driver's door is openable and closable, determine whether the front passenger's door is openable and closable and whether there is an occupant in the front passenger seat provided in the vehicle;
when the controller determines that the front passenger's door is not openable and closable and that there is an occupant in the front passenger seat, move the driver seat and the front passenger seat backward toward the rear side in the front-rear direction of the vehicle along with the at least an upper part of the console member by controlling the first actuator, the second actuator, and the third actuator;
when the controller determines that the front passenger's door is not openable and closable and that there is no occupant in the front passenger seat, move only the driver seat backward toward the rear side in the front-rear direction of the vehicle by controlling the second actuator;
when the controller determines that the front passenger's door is openable and closable and that there is an occupant in the front passenger seat, move only the driver seat and the front passenger seat backward toward the rear side in the front-rear direction of the vehicle by controlling the second actuator and the third actuator; and
when the controller determines that the front passenger's door is openable and closable and that there is no occupant in the front passenger seat, move only the driver seat backward toward the rear side in the front-rear direction of the vehicle by controlling the second actuator.

5. The exit assistance device according to any one of claim 3, wherein the controller is configured to:
determine whether the console member is protruded frontward beyond the driver seat and the front passenger seat;
when the controller determines that the console member is protruded frontward beyond the driver seat and the front passenger seat, determine whether the driver's door is openable and closable and whether the front passenger's door is openable and closable;
when the controller determines that the console member is not protruded frontward beyond the driver seat and the front passenger seat, determine whether there is an occupant in the front passenger seat provided in the vehicle;
when the controller determines that there is an occupant in the front passenger seat, move only the driver seat and the front passenger seat backward toward the rear side in the front-rear direction of the vehicle by controlling the second actuator and the third actuator; and
when the controller determines that there is no occupant in the front passenger seat, move only the driver seat backward toward the rear side in the front-rear direction of the vehicle by controlling the second actuator.

6. The exit assistance device according to any one of claim 4, wherein the controller is configured to:
determine whether the console member is protruded frontward beyond the driver seat and the front passenger seat;
when the controller determines that the console member is protruded frontward beyond the driver seat and the front passenger seat, determine whether the driver's door is openable and closable and whether the front passenger's door is openable and closable;
when the controller determines that the console member is not protruded frontward beyond the driver seat and the front passenger seat, determine whether there is an occupant in the front passenger seat provided in the vehicle;
when the controller determines that there is an occupant in the front passenger seat, move only the driver seat and the front passenger seat backward toward the rear side in the front-rear direction of the vehicle by controlling the second actuator and the third actuator; and
when the controller determines that there is no occupant in the front passenger seat, move only the driver seat backward toward the rear side in the front-rear direction of the vehicle by controlling the second actuator.

7. The exit assistance device according to claim 5, wherein the controller is configured to move the at least an upper part of the console member backward toward the rear side in the front-rear direction of the vehicle such that a front end of the at least an upper part of the console member to be moved backward by the first actuator is located rearward of a seatback of the driver seat and a seatback of the front passenger seat.

8. The exit assistance device according to claim 6, wherein the controller is configured to move the at least an upper part of the console member backward toward the rear side in the front-rear direction of the vehicle such that a front end of the at least an upper part of the console member to be moved backward by the first actuator is located rearward of a seatback of the driver seat and a seatback of the front passenger seat.

9. The exit assistance device according to claim 7, wherein the controller is configured to, when an operation to put the vehicle in a travelable state is performed in a moved-backward state in which one or more of the at least an upper part of the console member, the driver seat, and the front passenger seat have been moved backward toward the rear side in the front-rear direction of the vehicle, move the one or more of the at least an upper part of the console member, the driver seat, and the front passenger seat that are in the moved-backward state frontward toward a front side in the front-rear direction of the vehicle by controlling one or more of the first actuator, the second actuator, and the third actuator.

10. The exit assistance device according to claim 8, wherein the controller is configured to, when an operation to put the vehicle in a travelable state is performed in a moved-backward state in which one or more of the at least an upper part of the console member, the driver seat, and the front passenger seat have been moved backward toward the rear side in the front-rear direction of the vehicle, move the one or more of the at least an upper part of the console member, the driver seat, and the front passenger seat that are in the moved-backward state frontward toward a front side in the front-rear direction of the vehicle by controlling one or more of the first actuator, the second actuator, and the third actuator.

11. An exit assistance device of a vehicle, the exit assistance device comprising:
a console member provided between a driver seat and a front passenger seat in a vehicle cabin of the vehicle;
a first actuator configured to move at least an upper part of the console member backward toward a rear side in a front-rear direction of the vehicle;
a circuitry configured to control the first actuator;
a driver-side sensor configured to detect an obstacle outside the vehicle within an opening-closing range of a driver's door configured to open and close when an occupant gets into or out of the driver seat; and
a front passenger-side sensor configured to detect an obstacle outside the vehicle within an opening-closing range of a front passenger's door configured to open and close when an occupant gets into or out of the front passenger seat, wherein the circuitry is configured to:
while the vehicle is stationary, determine whether the driver's door is openable and closable based on the detection by the driver-side sensor, and determine whether the front passenger's door is openable and closable based on the detection by the front passenger-side sensor; and
when the circuitry determines that the driver's door is not openable and closable or when the circuitry determines that the front passenger's door is not openable and closable, move the at least an upper part of the console member backward toward the rear side in the front-rear direction of the vehicle by controlling the first actuator.
